(19) United States
(12) Patent Application Publication
(10) Pub. No.: US 2009/0106264 A1
(43) Pub. Date: Apr. 23, 2009

(54) STATUS PROCESSOR AND STATUS DISPLAY METHOD

(75) Inventor: Yusaku TAKAHASHI, Obu-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 12/254,772

(22) Filed: Oct. 20, 2008

(30) Foreign Application Priority Data
Oct. 18, 2007 (JP) 2007-271563

(51) Int. Cl. G06F 17/30

(52) U.S. Cl. 707/10; 707/E17.01; 707/E17.044

(57) ABSTRACT

A status processor, configured to connect to a network, includes a media connecting unit configured to connect at least one storage media. The status processor further includes a server unit configured to transmit data. The status processor still further includes a directory name setting unit configured to create a status-reflecting directory name on the server unit. The status-reflecting directory name corresponds to a status of at least one of the status processor and the storage media. The server unit is configured to transmit data that indicates an existence of the directory having the status-reflecting directory name to the network.

### CROSS REFERENCE TO RELATED APPLICATION

This application claims priority to and the benefit of Japanese Patent Application No. 2007-271563, filed Oct. 18, 2007, the entire subject matter and disclosure of which is incorporated herein by reference.

### BACKGROUND

1. Field of the Invention

The present invention relates to a status processor for outputting status.

2. Description of the Related Art

A mechanism of transferring a file according to a known protocol, e.g., a File Transfer Protocol (FTP) has been heretofore known. A memory card, e.g., an example of storage media having a nonvolatile memory such as a flash memory packaged as a card has been widespread in recent years. This memory card has been popularized as a medium for storing data used in a digital device such as a digital camera or a portable music player. The specification of the memory card has been not standardized, so that various kinds of memory cards such as Compact Flash™ (registered trademark, hereinafter referred to as “CF”), Smart Media™ (registered trademark, hereinafter referred to as “SM”), Memory Stick™ (registered trademark, hereinafter referred to as “MS”) and SD Memory Card™ (registered trademark, hereinafter referred to as “SD”) are on the market.

A personal computer (“PC”) or the like can communicate with a memory card reader-writer, hereinafter referred to as “reader-writer,” for reading data from a memory card and writing data in the memory card to thereby access the memory card connected to the reader-writer. A printer or the like equipped with such a reader-writer has been popularized in recent years. For example, a memory card in which an image data file saved in JPEG format or the like is written can be connected to the reader-writer so that an image can be printed directly without interposition of any PC.

If an FTP client program is installed in a PC or the like while an server program is provided on the card reader side, a memory card used as a storage of a file of image data taken by a digital camera or a camera-including portable phone can be connected to the reader-writer so that the data file stored in the memory card can be transferred to the PC according to the FTP. That is, the reader-writer can be used as an external FTP type processing apparatus attached to the PC.

FTP and some other known protocols are not such that an server handles recording media, e.g., removable media, hereinafter referred to as “media”. Accordingly, when an server is provided in the FTP type processing apparatus, or a peripheral device such as a printer equipped with the FTP type processing apparatus, the host could not be informed of the status of connection of a recording medium to a media connection portion, and the status of the recording medium connected to the media connection portion.

When, for example, a PC intends to access an FTP type processing apparatus to which no recording medium has been connected, the FTP type processing apparatus may not recognize any recording medium which has recorded a file to be handled according to a request received from the PC or a directory to store the file. Accordingly, the FTP type processing apparatus outputs a response code “550” and a message train “You cannot change directory” indicating that the request made in the FTP cannot be executed because access privileges are on the file system side.

When a general user unacquainted with the FTP protocols views this code, it is difficult for the general user to grasp that this code was caused by no medium connected to a slot. In addition, even when a user acquainted with the FTP views this code, the user cannot find what caused this code since there could be many conceivable causes, e.g., access privileges, and file system side rights.

This is because the situation that the server was working while there was no recording medium was unexpected in the conventional FTP protocol. Although it may be therefore thought of that the FTP protocol itself is extended or changed to change the output contents of the response code to contents more easily understandable to users, users of existing FTP clients used commonly cannot receive the benefit of extension or change of the FTP protocol even when the FTP protocol itself is extended or changed. In addition, the extension or change of the protocol is very bothersome because it is necessary to obtain the approval of the extension or change of the protocol through an international organization.

### SUMMARY

A need has arisen to provide an improvement in which a host apparatus side can be informed of the connection status of a recording medium server without extension or change of the protocol in an environment. According to an embodiment of the present invention, a status processor configured to connect to a network, comprising a media connecting unit configured to connect at least one storage media. The status processor further comprising a server unit configured to transmit data. The status processor still further comprising a directory name setting unit configured to create a status-reflecting directory name on the server unit. The status-reflecting directory name corresponds to a status of at least one of the status processor and the storage media. The server unit is configured to transmit data that indicates an existence of the directory having the status-reflecting directory name to the network.

According to another embodiment of the present invention, a status displaying method using a host device and a processor communicable with the host device via a network. The host device comprising a display unit, the processor comprising a media connecting unit for connecting a storage media. The status displaying method comprising creating a status-reflecting directory name corresponding to a status of at least one of the processor and the storage media. The status displaying method further comprising transmitting data that indicates an existence of the directory having the status-reflecting directory name. The status displaying method still further comprising displaying the transmitted data on the displaying unit.

### BRIEF DESCRIPTION OF THE DRAWINGS

FIG. 1 is a block diagram showing the schematic overall configuration of an FTP system according to an embodiment of the invention;

FIG. 2 is a perspective view showing an example of a printer applied to the FTP system according to an embodiment of the invention;

FIG. 3 is a block diagram showing an example of electrical configuration of the printer according to an embodiment of the invention;

FIGS. 4A and 4B are views showing an example of a status reflection directory name table and a status reflection file name table according to an embodiment of the invention;

FIGS. 5A to 5C are views showing a first example of icon display for a directory having a status reflection directory name, and a file having a status reflection file name, according to an embodiment of the invention;

FIG. 6 is a view showing an example of list display in the inside of a file storage directory of a memory card according to an embodiment of the invention.

FIG. 7 is a view showing a second example of icon display for a directory having a status reflection directory name according to an embodiment of the invention.

FIG. 8 is a view showing a third example of icon display for a directory having a status reflection directory name according to an embodiment of the invention.

FIG. 9 is a sequence diagram showing an example of operation of the FTP system according to an embodiment of the invention;

FIG. 10 is a view showing an example of display of status reflection data according to an embodiment of the invention;

FIG. 11 is a flow chart of server processing in the printer according to an embodiment of the invention;

FIG. 12 is a flow chart of virtual directory tree initialization processing in the printer according to an embodiment of the invention;

FIG. 13 is a flow chart of steady-state operation processing in the printer according to an embodiment of the invention;

FIG. 14 is a flow chart of a change directory, e.g., “cd” process in the printer according to an embodiment of the invention;

FIG. 15 is a flow chart of a “list” process in the printer according to an embodiment of the invention;

FIG. 16 is a flow chart of a “get” process in the printer according to an embodiment of the invention;

FIG. 17 is a flow chart of a “put” process in the printer according to an embodiment of the invention;

FIG. 18 is a flow chart of a virtual directory information generating process in the printer according to an embodiment of the invention;

FIGS. 19A and 19B are views showing an example of the virtual directory tree according to an embodiment of the invention;

FIG. 20 is a view showing an example of a system area according to an embodiment of the invention;

FIG. 21 is a view showing a fourth example of icon display for a directory having a status reflection directory name, and a file having a status reflection file name, according to an embodiment of the invention; and

FIG. 22 is a flow chart of a slot status monitoring process in the printer according to an embodiment of the invention.

### DETAILED DESCRIPTION OF THE PREFERRED EMBODIMENTS

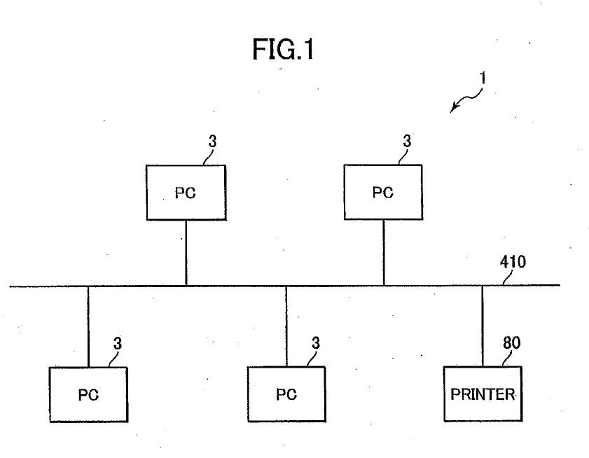

An FTP system according to an embodiment of the invention will be described below with reference to the drawings appropriately. FIG. 1 is a block diagram showing the schematic configuration of the system 1, e.g., an FTP system, according to an embodiment of the invention. The System 1 comprises a printer 80, and host apparatuses, e.g., personal computers, hereinafter interchangeably referred to as “PCs” 3 which may use the printer 80 as a network printer. In the system 1, the printer 80 and the PCs 3 may be connected to one another by a network 410, such that the printer 80 and the PCs 3 may communicate with one another. Network 410 may be a wired network as shown in FIG. 1, or may be a wireless network.

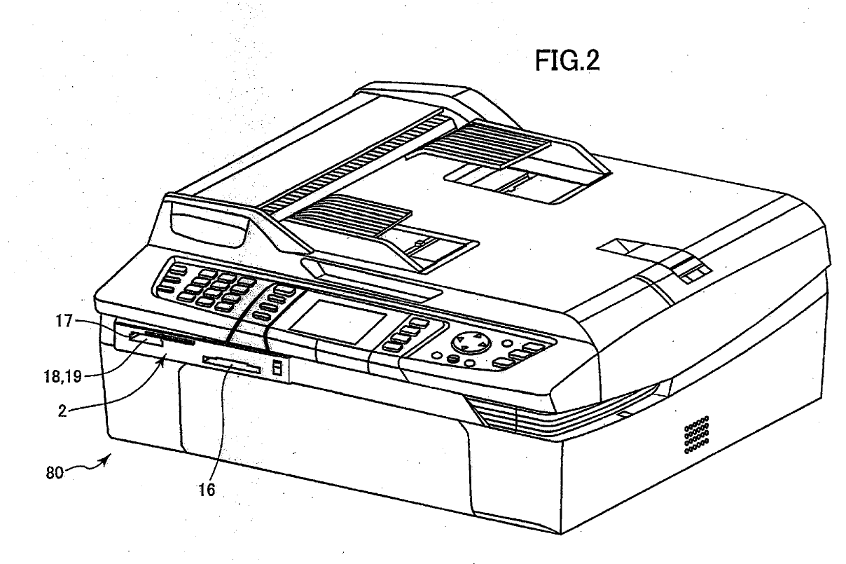

FIG. 2 shows the visual external configuration of the printer 80 according to an embodiment of the invention. The printer 80 is a multifunction peripheral (“MFP”) device which may be formed as a printer composite machine, comprising a multi reader-writer 2 incorporated in the printer, which may serve as an FTP type processing apparatus. Specifically, the printer 80 may be integrated with the multi reader-writer 2 which may be disposed in a front surface of the printer 80, such that media connection slots, e.g., “slots” 16 to 19 may be exposed. Accordingly, the printer 80 may have a printer function, a scanner function, a copying function, a facsimile function, etc.

Incidentally, USB connection portions may be provided in place of or in addition to the media connection slots, such that a USB memory may be connected as a recording medium to any one of the USB connection portions. Alternatively, wireless connection portions may be provided such that a memory card having a wireless function may be connected as a recording medium to any one of the wireless connection portions.

The printer 80 may be connected to any one or more of the PCs 3 by the network, and may function as a reader-writer device which may perform data communication between the PC 3 and a memory card inserted in the multi reader-writer 2. As shown in FIG. 1, the printer 80 further may print an image or a document on a predetermined sheet of paper based on print data transmitted from the PC 3. The printer 80 further may print an image or a document on a predetermined sheet of paper based on print data read from the memory card, e.g., storage medium, by the multi reader-writer 2, e.g., the printer 80 may perform direct printing. In addition, the printer 80 may transmit image data read by a scanner portion to the PC 3 or may copy an image read by the scanner portion by using a printer portion.

As shown in FIG. 2, the multi reader-writer 2 of the printer 80 may comprise media connection slots 16 to 19. These media connection slots may comprise a first slot 16 for inserting a first memory card 11, a second slot 17 for inserting a second memory card 12, a third slot 18 for inserting a third memory card 13, and a fourth slot 19 for inserting a fourth memory card 14.

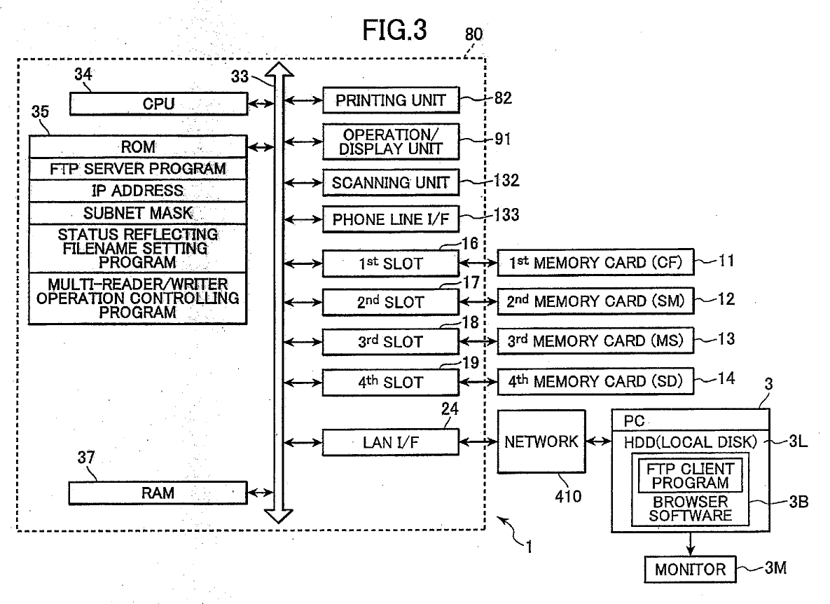

FIG. 3 is a block diagram showing the electrical configuration of the printer 80 according to an embodiment of the invention. The printer 80 may comprise a CPU 34 for controlling respective constituent parts, a ROM 35, which may comprise a nonvolatile memory, e.g., a flash memory, for storing control programs, various data, etc., and a RAM 37 which may be used as a work area for arithmetic operation performed by the CPU 34. The CPU 34, the ROM 35 and the RAM 37 may be connected to one another through a bus 33, such that data may be transferred between them. The respective slots 16 to 19 may be connected to the bus 33 through a flash memory control LSI. The first to fourth memory cards 11 to 14 detachably attached to the slots 16 to 19 may be card type storage media, each of which may be equipped with a flash memory such as CF, SM, MS or SD capable of writing, rewriting, erasing and reading data. Any other suitable type of memory card selected alternatively may be attached to each of the slots 16 to 19.

A printer portion 82, a scanner portion 132, a telephone line I/F 133 and an operation and display portion 91 comprising an LCD, a keyboard, cursor control keys, etc., may be connected to the bus 33. A LAN I/F 24 further may be connected to the bus 33. The LAN I/F 24 may be connected to one of the PCs 3 as a host apparatus through a first network. As shown in FIG. 1, the PCs 3 and the printer 80 may be connected to one another by the TCP/IP network 410.

A program for controlling the operation of the multi reader-writer 2 and various control programs for managing print control, scan control, facsimile communication control, etc., may be stored in the ROM 35. The CPU 34 may execute these programs, while the RAM 37 may be used as a work area, e.g., an area of storage used to facilitate the performance of calculations, to thereby perform comprehensive operation control of the printer composite machine.

An server program further may be stored in the ROM 35. An IP address and a subnet mask for identifying the printer 80 on the TCP/IP network 410 further may be stored in the ROM 35. In addition, a status reflection directory name decision program may be stored in the ROM 35.

The memory cards, e.g., the recording media or storage media, 11 to 14 may be connected to the media connection slots 16 to 19, respectively. Each of the PCs 3 may comprise a local disc 3L, which may comprise a hard disc or other suitable medium, and a monitor 3M which may comprise a liquid crystal display or the like. A browser including an FTP client program further may be installed in the local disc 3L.

The various control programs, the status reflection directory name decision program and the server program may be executed by the CPU 34 on the printer 80 side, such that an server unit and a status reflection directory name decision unit may be implemented on the system.

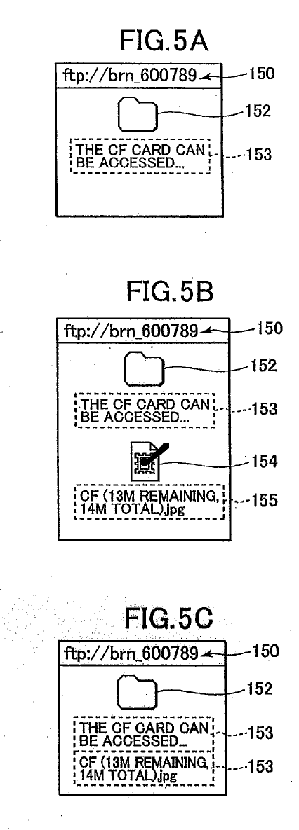

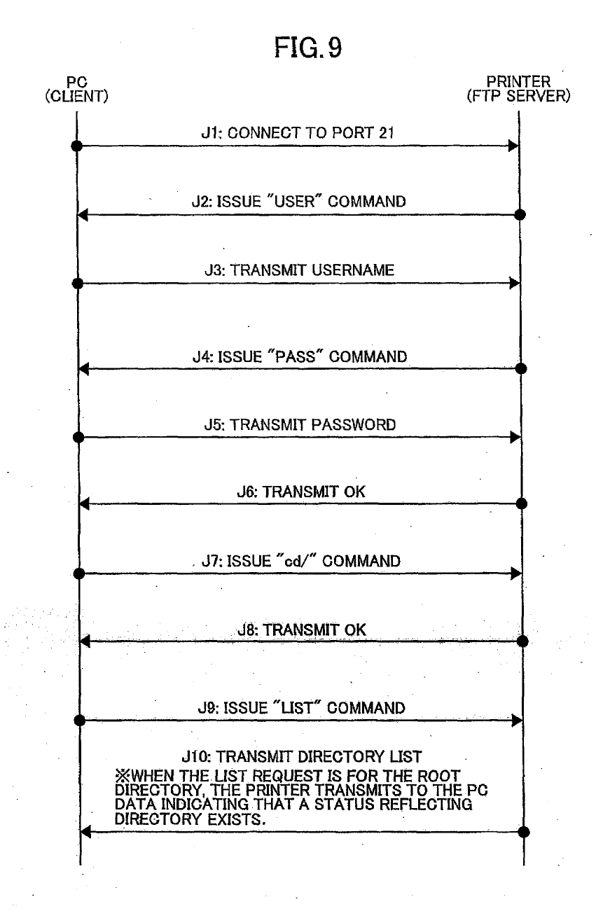

FIG. 9 describes a data sequence in the communication system 1, e.g., a sequence diagram, according to an embodiment of the invention. The sequence diagram may start when the user starts up the browser including the FTP client function on the PC 3 side and, as shown in FIGS. 5A to 5C, enters a node name, e.g., ftp://brn_{—}600789 of the printer 80 to start access 5C. A short cut to the node name ftp://brn_{—}600789 may be prepared on the PC 3 side, such that when an operation may be made on the short cut, the PC 3 may access the printer 80 directly after the browser starts.

First, at Step J1, the PC 3, e.g., the FTP client may connect to a connect port 21, which may be allotted to the FTP in order to access the printer 80, e.g., the server. At Step J2, the printer 80 may send a user name request response to the PC 3. Upon reception of the user name request response, at Step J3, the PC 3 may send a user name to the printer 80 in order to login the server.

At Step J4, the printer 80 may send a password request response to the PC 3. Upon reception of the password request response, at Step J5, the PC 3 may send a password entered in the host apparatus to the printer 80. The printer 80 may authenticate a login user based on the received password and user name, and may, at Step J6, send a reply to the PC 3 to permit the login user to login the server (printer 80) when authentication is accepted.

Successively, the PC 3, with permission for the user to login the server, at Step J7, may issue a command “cd /”, which means “change directory root” to request access to the root directory. Upon reception of this command, at Step J8, the printer 80 may access the root directory, e.g., may intend to change the current directory to the root directory, and may send a code indicating success back to the PC 3. If the printer 80 fails in access to the root directory, the printer 80 may send a response code “550” or the like back to the PC 3. In this embodiment, a code indicating success in access to the root directory may be sent back to the PC 3, even when there is no recording medium attached.

Upon reception of the code indicating success in access to the root directory, at Step J9, the PC 3 may issue a list command for the root directory. Upon reception of the list command, the printer 80 may send information which indicates that a directory having a status reflection directory name, which may be decided in accordance with the status of the media connection portion or the status of the recording medium by the status reflection directory name decision program shown in FIG. 3, is present in the root directory, e.g., as in Step J8.

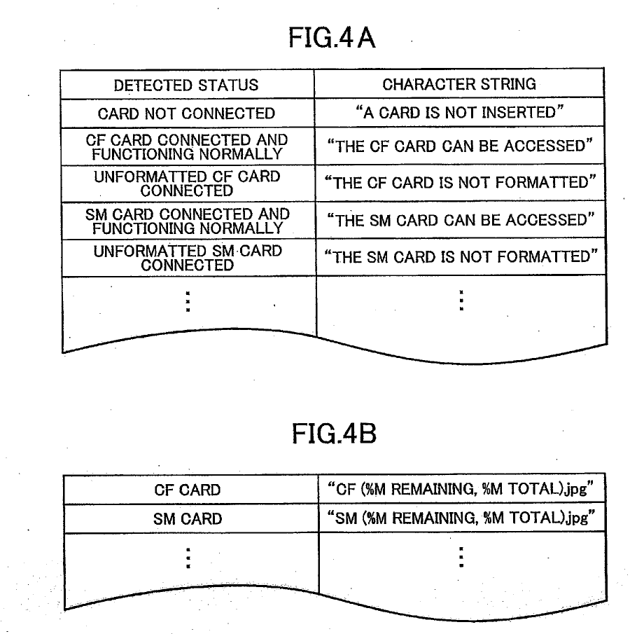

FIG. 4A shows an example of a character string table which CPU 34 may refer to when a directory name indicating the status of the media connection portion or the recording medium is decided. FIG. 4B shows an example of a character string table which further may be referred to when the recording medium has been already formatted.

In this embodiment, notice of the “presence” of a directory having a status reflection directory name is sent even when a directory having such a status reflection directory name is not present in the root directory. Upon reception of the notice of the presence of the directory, the PC 3 displays the presence of this directory in the root directory on a screen as notified.

FIG. 5A shows an example of the status reflection directory name displayed by the PC 3. As shown in FIG. 5A, the presence of the directory having the status reflection directory name may be displayed in a window 150 of the browser. When, for example, a formatted CF has been already attached to a specific slot such as a CF slot in the printer 80, “CF card access-enabled” may be set as the status reflection directory name 153, and may be displayed with an icon 152. In this manner, the user can view the status of connection of the recording medium to the printer 80 by viewing the information expressed in natural language.

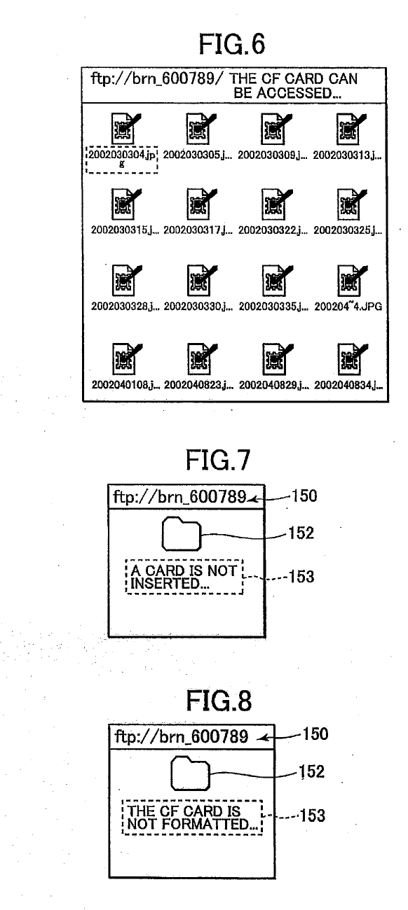

Further, the printer 80 may create the status reflection directory name as a directory name indicating the top level directory, e.g., a predetermined directory, of the recording medium, and may send the directory name to the PC 3. When the PC 3 requests access to this directory, e.g., in response to the user's opening this directory 152, specifically, sending of “CF card access-enabled” and sending of the list command are performed successively, the printer 80 may send file names of files stored in the top level directory of the recording medium back to the PC 3. Upon reception of the file names, the PC 3 may display a list of icons corresponding to the files and subdirectories stored in the attached recording medium, as shown in FIG. 6.

Alternatively, the printer 80 may send the PC 3 information indicating the presence of a directory having a status reflection directory name, based on a reflection of the capacity of the recording medium, e.g., in which the name of the directory indicates the capacity of the recording medium. As shown in FIG. 5B, the printer 80 may send the PC 3 information indicating the presence of a file 154 having a status reflection file name 155, based on a reflection of the capacity of the recording medium, or based on other information of the recording medium, e.g., the format or the status of the recording medium.

As an example shown in FIG. 5C, the printer 80 may send the PC 3 information indicating the presence of a directory 152 having status reflection directory names 153 based on reflecting information of both the connection of the recording medium and the capacity of the recording medium.

As shown in FIG. 7, if there is no recording medium attached to any one of the slots, “card not inserted” may be created as the status reflection directory name 153. If the attached recording medium, e.g., the case of CF as shown in FIG. 8, has not been formatted yet, “CF card unformatted” may be created as the status reflection directory name 153.

When a configuration is made such that the printer 80 may send information indicating the presence of a directory having a status reflection directory name based on a reflection of the status of the printer 80 or of the recording medium, back to the PC 3 when the PC 3 issues the list command again, the user of the PC 3 may view the status of the printer 80 and any media cards at the point of time when the PC 3 issued the list command again, even if the status of connection may have changed.

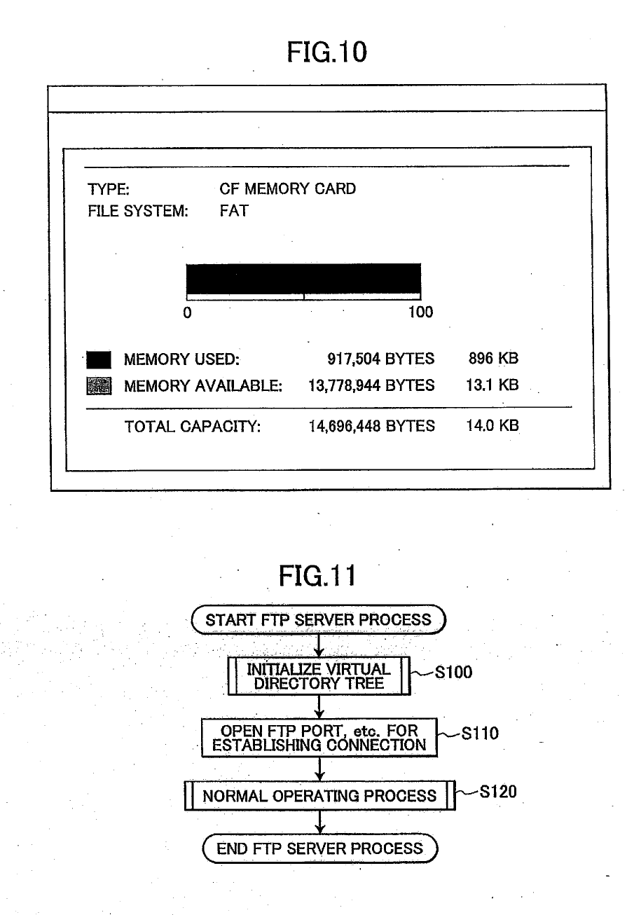

FIG. 10 shows the contents, e.g., the status reflection data, of a file 154 sent from the printer 80, and displayed on the PC 3. These contents may be shown when an icon of the file 154 having a status reflection file name 155, based on reflection of the capacity of the recording medium, as shown in FIG. 5B, is clicked. Accordingly, the user may obtain more detailed information or additional information of the status shown from the file name by a designating browsing of the file, and confirming the contents of the file by viewing the displayed data. That is, when more detailed information or additional information than the contents of the status of the media connection portion or the recording medium, which may be displayed as characters based on the directory name, is needed, the contents of the status may be displayed by use file name, e.g., status reflection file name information. Although .jpg extensions are shown in FIG. 5B, other file formats and extensions, e.g., .txt, .pdf, .xls, etc. may be the format of the file, and may appear in other embodiments.

FIGS. 11 to 18 are operation flow charts describing processing in the invention, which may show server processing executed in accordance with the server program by the CPU 34 in the printer 80. The server processing starts in accordance with the start of the printer 80.

In the server processing shown in FIG. 11, at Step S100, a virtual directory tree may be initialized, such that a directory tree to be managed by the CPU in the server processing may be formed on a memory such as a RAM. Successively at Step S10, preparations of a server for connection to a network apparatus, e.g., opening of an FTP port, may be made. Successively at Step S120, steady-state operation processing of the server, e.g., reception of a file access request, reply to the request, etc. may be executed. Thereafter, the steady-state operation may be continued unless the printer 80 is powered off or reset.

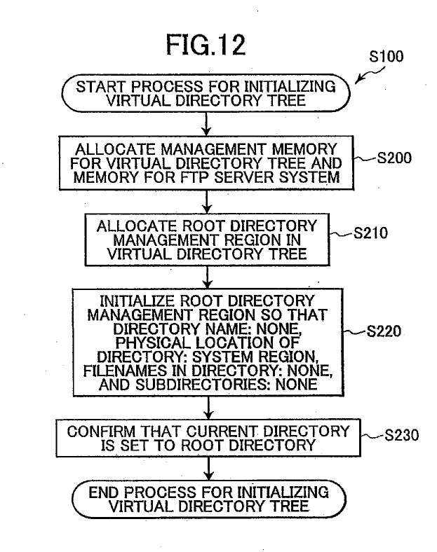

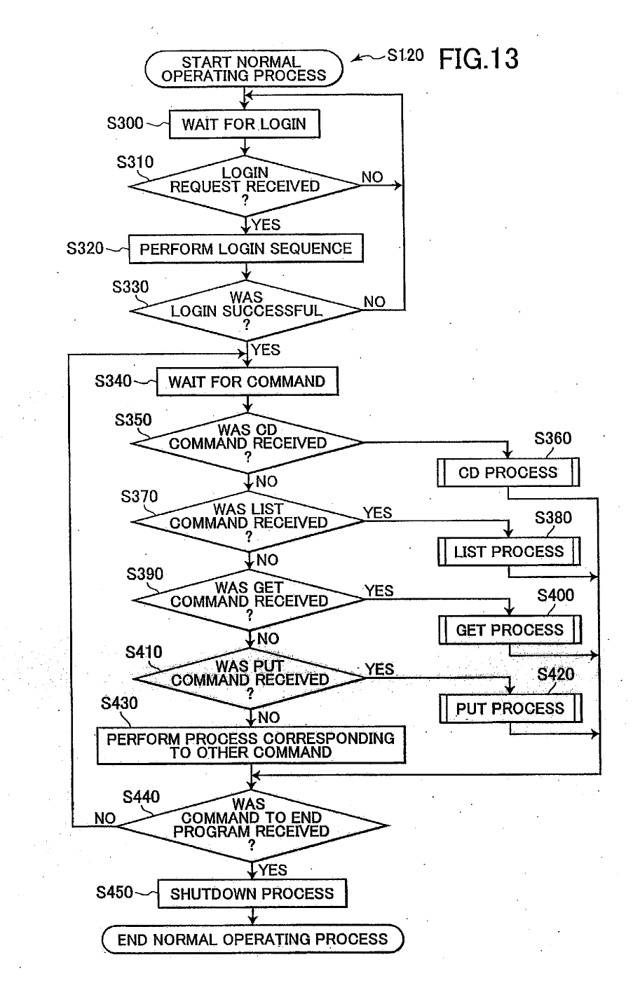

FIG. 12 is a detailed flow chart showing the initialization of the virtual directory tree in S110 in FIG. 11. First, at Step S200, the CPU 34 may reserve a memory for management of the structure of the virtual directory tree and a memory for management of the server system, in the RAM or other memory. Successively, at Step S210, a management area for the root directory of the server may be reserved in the virtual directory tree on the reserved memory. Then, the reserved root directory management area may be initialized. In this embodiment, attributes indicating that the directory has no directory name, the actual location of the directory is present in the system area, there is no file name of any file stored in the directory, e.g., there is no file in the directory, and there is no sub-directory in the directory, may be set in the management area. Successively, at Step S230, the aforementioned root directory may be recognized to be the current directory. When such recognition is made, the printer 80 may send file and sub-directory names of files and sub-directories present in the root directory as the current directory even if the client, e.g., the FTP client accessing the server may transmit the list command without “cd /”.

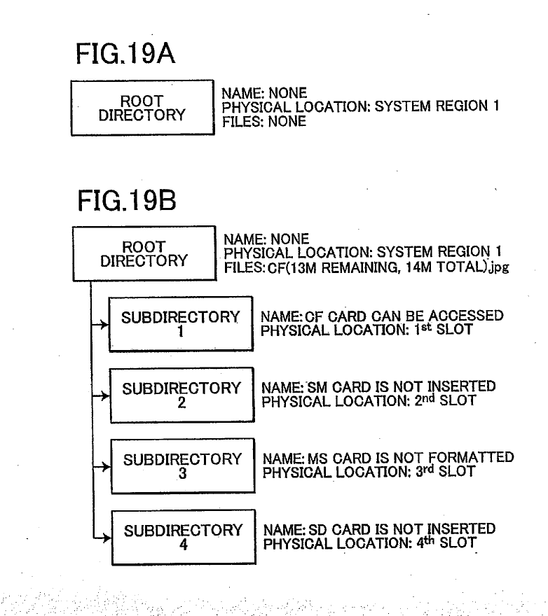

FIG. 19A is a conceptual view showing a virtual directory tree formed by initialization of the virtual directory tree. A conceptual view concerned with a system area of a memory reserved by initialization of the virtual directory tree is not shown.

FIG. 13 is a detailed flow chart showing steady-state operation processing as shown in Step S120 of FIG. 11. When initialization for the server is completed, as shown in Step S300, the CPU 34 may enter in a login waiting state to wait for login, similarly to Step J1 of FIG. 9. If there is no login request from the client, e.g., “NO” at Step S310, the CPU 34 may enter a login waiting state again. If there is a login request from the client, e.g., “YES” at Step S310, the CPU 34 may execute a login sequence at Step S320, which may be similar to Steps J2 to J5 in FIG. 9. If the login sequence fails, e.g., “NO” at Step S330, the CPU 34 may enter a login waiting state again. If the login sequence succeeds, e.g., “YES” at Step S330, then at Step S340, the CPU 34 may transmit a code indicating success in login to the client, similarly to Step J6 in FIG. 9, and then may enter a command waiting state to wait for a command, e.g., an FTP command from the client. If there is a “cd” command from the client, e.g., “YES” at Step S350, then at Step S360, the CPU 34 may execute a cd process in accordance with the command.

If there is a “list” command from the client, e.g., “YES” at Step S370, then at Step S380, the CPU 34 may execute a list process in accordance with the command. If there is a “get” command from the client, e.g., “YES” at Step S390, then at Step S400, the CPU 34 may execute a get process in accordance with the command. If there is a “put” command from the client, e.g., “YES” at Step S410, then at Step S420, CPU 34 may execute a put process in accordance with the command. If there is another command from the client, then at Step S430, CPU 34 may execute a process in accordance with the command.

If execution of such a process is completed, or there is no command from the client, then at Step S440, CPU 34 may judge whether or not there is an instruction to terminate the program, e.g., because of a shutdown process or the like, of the printer 80.

If there is no instruction to terminate the program, e.g., “NO” at Step S440, the CPU 34 may enter a command waiting state again.

If there is an instruction to terminate the program, e.g., “YES” at Step S440, then at Step S450, the CPU 34 may perform a shutdown process to terminate the function of the server, and then may terminate the steady-state operation.

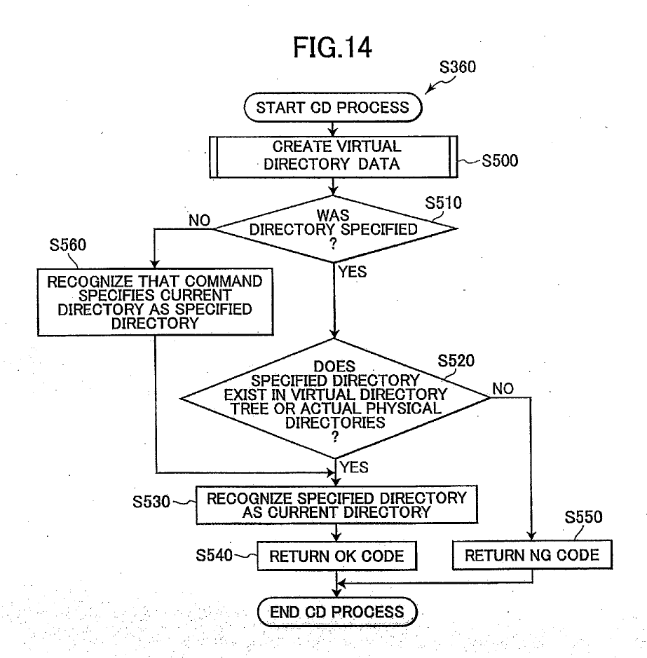

FIG. 14 is a detailed flow chart showing the change directory, e.g., “cd” process shown in Step S360 of FIG. 12. In the cd process, the directory designated by the cd command may be recognized as the current directory. In other words, a process of switching the current directory may be performed. At Step S500, the CPU 34 first may generate virtual directory information based on the current apparatus status. Successively, if the target directory is designated by the command, e.g., “YES” at Step S510, then at Step S520, the CPU 34 may judge whether or not the directory designated by the command from the client is present in either of the virtual directory tree and the actual directory.

If the designated directory is present in either of the virtual directory tree and the actual directory, e.g., “YES” at Step S520, then at Step S530, the CPU 34 may recognize the designated directory as the current directory, and at Step S540 may send an OK code indicating success in the command to the client, and then may terminate the cd process. If the designated directory is present neither in the virtual directory tree nor in the actual directory, e.g., “NO” at Step S520, the CPU 34 may not recognize the designated directory as the current directory, and may, at Step S550, send an NG code, indicating failure in the command to the client, and then terminate the cd process.

On the other hand, if the target directory is not designated by the command in Step S510, e.g., “NO” at Step S510, the CPU 34 may, at Step S560, recognize that the current directory is designated by the command, and may execute processing in and after Step S530.

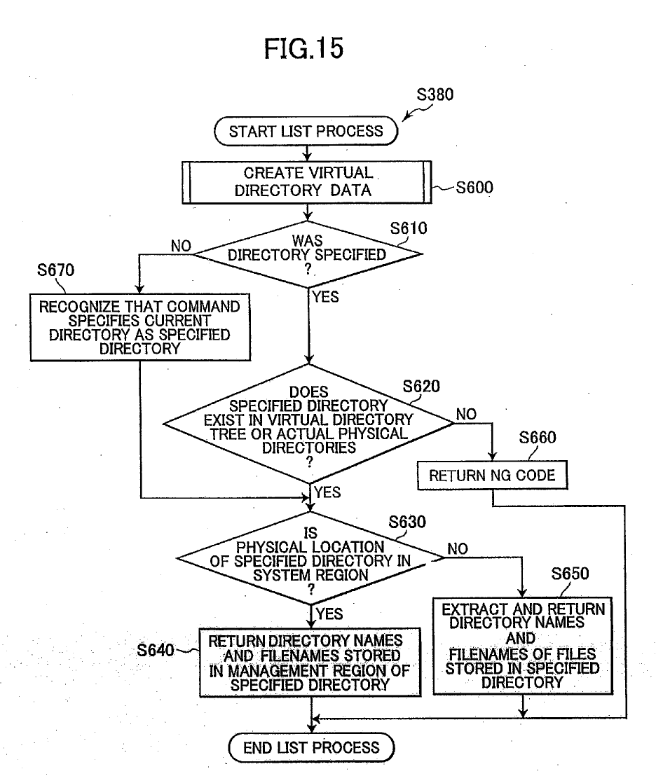

FIG. 15 is a detailed flow chart showing the list process shown in Step S380 of FIG. 12. In the list process, the file and directory names of files and directories present in the directory designated by the list command may be sent back to the client. In other words, a process of showing the client a list of files and directories in the directory designated by the client is performed.

At Step S600, CPU 34 first may generate virtual directory information based on the current apparatus status. Successively, if the target directory is designated by the command “YES” at Step S610, then at Step S620, CPU 34 may judge whether or not the directory designated by the command from the client is present in either of the virtual directory tree and the actual directory.

If the designated directory is present in either of the virtual directory tree and the actual directory, e.g., “YES” at Step S620, then at Step S630, CPU 34 further may judge whether or not the actual location of the designated directory is in the system area.

If the actual location of the designated directory is in the system area, e.g., “YES” at Step S630, then at Step S640, the CPU 34 may send file names and sub-directory names stored in the management area for the designated directory to the client, and then may terminate the list process. That is, file names and directory names proper to the present invention, e.g., file names and directory names indicating the status of the printer 80 or the recording medium attached to the printer 80, may be sent to the client.

If the actual location of the designated directory is not in the system area, or in other words, if the actual location of the designated directory is in a storage device such as the recording medium, e.g., “NO” at Step S630, then at Step S650, the CPU 34 may send file names and sub-directory names stored in the designated directory to the client, and then may terminate the list process. That is, file names and directory names of files and directories actually stored in the recording medium or the like may be sent to the client.

If the designated directory is present neither in the virtual directory tree nor in the actual directory, e.g., “NO” at Step S620, then at Step S660, the CPU 34 may send an NG code indicating failure in the command to the client, and then may terminate the list process. On the other hand, if the target directory is not designated by the command in Step S610, e.g., “NO” at Step S610, then at Step S670, the CPU 34 may recognize that the current directory is designated by the command, and then may execute processing in and after Step S630.

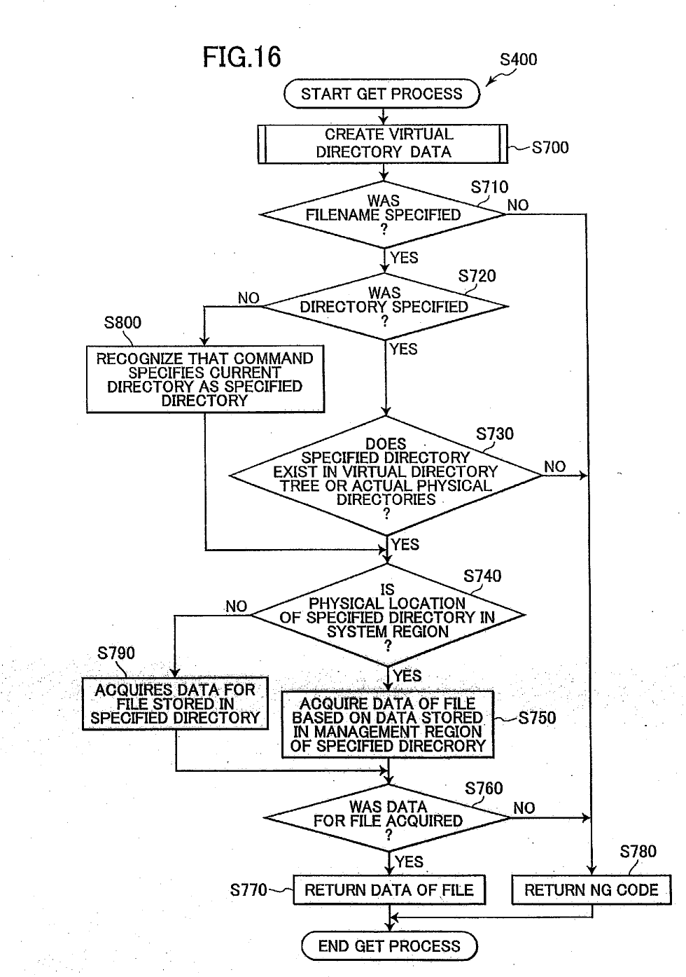

FIG. 16 is a detailed flow chart showing the get process in S400 of FIG. 12. In the get process, a process of sending actual data of a file designated by a get command back to the client may be performed. In other words, the get command allows the client to acquire actual data of a file designated by the client.

At Step S700, the CPU 34 first may generate virtual directory information, based on the current apparatus status. Successively, at Step S710, the CPU 34 may judge whether or not the target file is designated by the command. If the target file is designated, then at Step S720, CPU 34 may judge whether or not a directory in which the target file is present, e.g., the target directory, may be is designated by the command.

If the target directory is designated by the command, e.g., “YES” at Step S720, then at Step S730, the CPU 34 may judge whether or not the directory designated by the command from the client is present in either of the virtual directory tree and the actual directory. If the designated directory is present in either of the virtual directory tree and the actual directory, e.g., “YES” at Step S730, then at Step S740, the CPU 34 further may judge whether or not the actual location of the designated directory is in the system area.

If the actual location of the designated directory is in the system area, e.g., “YES” at Step S740, then at Step S750, the CPU 34 may acquire actual data of the file based on information stored in the management area for the designated directory.

If the actual data of the file are acquired, e.g., “YES” at Step S760, then at Step S770, the CPU 34 may send the actual data to the client and then may terminate the get process. That is, the actual data of the file proper to the present invention, e.g., actual data of a file indicating the status of the printer 80 or the recording medium attached to the printer 80, may be sent to the client.

If the actual data of the file are not acquired, e.g., “NO” at Step S760, then at Step S780, CPU 34 may send an NG code indicating failure in the command to the client, and then may terminate the get process.

If the actual location of the designated directory is not in the system area, in other words, if the actual location of the designated directory is in a storage device such as the recording medium, e.g., “NO” at Step S740, then at Step S790, CPU 34 may acquire actual data of the file stored in the designated directory and then may execute processing in and after Step S760. That is, actual data of the file actually stored in the recording medium or the like may be sent to the client.

If the designated directory is present neither in the virtual directory tree nor in the actual directory, e.g., “NO” at Step S730, then at Step S780, the CPU 34 may send an NG code indicating failure in the command to the client and then may terminate the get process.

On the other hand, if the target directory is not designated by the command in Step S720, e.g. “NO” at Step S720: NO, then at Step S800, CPU 34 may recognize that the command designates a file in the current directory as the target file, and then may execute processing in and after Step S740.

If the target file is not designated by the command, e.g., “NO” at Step S710, then at Step S780, the CPU 34 may send an NG code, which may indicate failure in the command to the client, and then may terminate the get process.

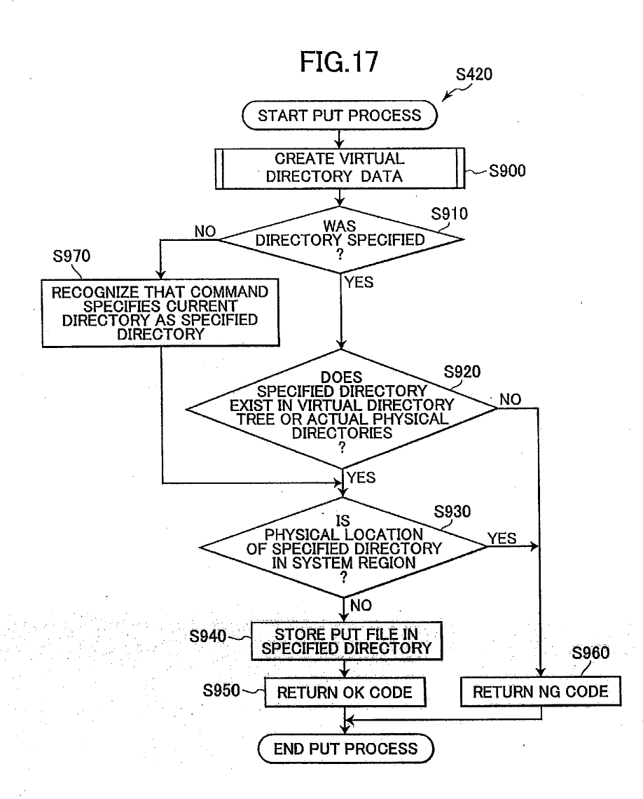

FIG. 17 is a detailed flow chart showing the put process in Step S420 of FIG. 12. In the put process, a process of storing the actual data of the file sent by the put command from the client in a storage device in the server may be performed. In other words, the server may write the actual data of the file designated by the client.

At Step S900, CPU 34 first may generate virtual directory information based on the current apparatus status Successively, at Step S910, the CPU 34 may judge whether or not a directory for storing the file, e.g., target directory, may be designated by the command.

If the target directory is designated by the command, e.g., “YES” at Step S910, then at Step S920, the CPU 34 may judge whether or not the directory designated by the command from the client is present in either of the virtual directory tree and the actual directory. If the designated directory is present in either of the virtual directory tree and the actual directory, e.g., “YES” at Step S920, then at Step S930, the CPU 34 further may judge whether or not the actual location of the designated directory is in the system area. If the actual location of the designated directory is in the system area, e.g., “YES” at Step S930, then at Step S960, the CPU 34 may send an NG code indicating failure in the command to the client, and then may terminate the put process. That is, the virtual directory provided specifically in order to send the file name, e.g., indicating the status of the printer 80 or the status of the recording medium attached to the printer 80, to the client, may be disabled from being accessed. This may prevent a situation in which, although the user of the PC 3 may assume that the actual data of the file have been written, the actual data of the file may not yet have been written, because of the presence of the virtual directory. By disabling access of the virtual directory at this step, a situation in which a user erroneously assumes that the actual data of the file have been written may be prevented.

If the actual location of the designated directory is not in the system area, e.g., if the actual location of the designated directory is in a storage device, e.g., the recording medium, e.g., “NO” at Step S930, then at Step S940, the CPU 34 may store the actual data in the designated directory, and then at Step S950 may send an OK code, which may indicate success in the command to the client, and then may terminate the put process. That is, the actual data are stored in the recording medium.

On the other hand, if the designated directory is present neither in the virtual directory tree nor in the actual directory, e.g., “NO” at Step S920, then at Step S960, the CPU 34 may send an NG code indicating failure in the command to the client, and then may terminate the put process. On the other hand, if the target directory is not designated by the command in S910, e.g., “NO” at Step S910, then at Step S970, the CPU 34 may recognize that the command designates a file in the current directory as the target file, and then may execute processing in and after Step S930.

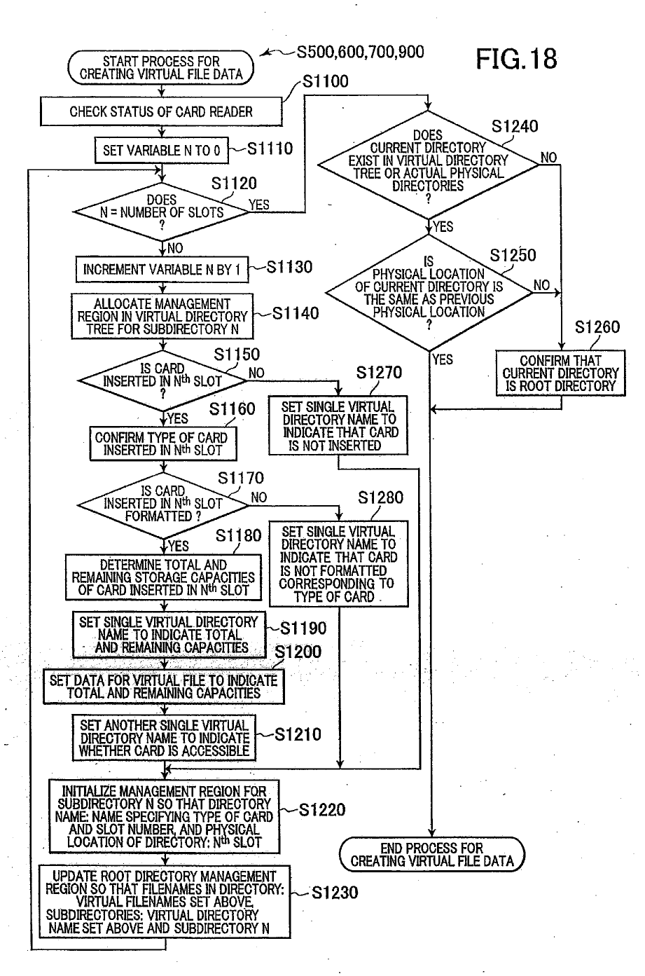

FIG. 18 is a detailed flow chart showing the virtual directory information generating process of FIGS. 14 to 17. In the virtual directory information generating process, a process of confirming the apparatus status of the printer 80 or the status of the recording medium attached to the printer 80, is performed. The virtual directory information generating process also may perform a step of creating a file name, a directory name and contents of data based on reflection of the status, e.g., creating contents of information for informing the FTP client of the server side status.

This process now will be described, with specific portions of the process discussed in further detail herein. The CPU 34 confirms the presence of the directory designated by the command, when the command is received from the client, e.g., the FTP client, regardless of whether the directory currently is available. Accordingly, even when the recording medium is detached from the printer 80, the CPU 34 may recognize the current directory as being on the virtual directory again. Accordingly, information indicating that the recording medium is not attached is on the root directory can be given to the FTP client in a form of a directory name.

Moreover, information regarding the number of media connection portions and the type of the recording medium allowed to be attached to each media connection portion may be acquired. Accordingly, a change in the number of media connection portions, etc., to the printer 80, may be reflected in the status reflection directory name.

Moreover, even when the recording medium in which the actual directory of the current directory is present is detached, the CPU 34 may recognize the current directory as being on the virtual directory again. Accordingly, the user may be informed of the replacement of the recording medium, such that the user may be prevented from mistaking a substituted new recording medium for the old recording medium from a previous moment.

In addition, the status of the printer 80 or the status of the recording medium attached to the media connection portion may be confirmed, and thus a change in the status of the printer 80 or a change in the status of the recording medium may be reflected in the status reflection directory name. Moreover, even when another recording medium is attached to the media connection portion instead, the status of the new recording medium may be reflected.

The process will now be described in more detail with reference to FIG. 18. At Step S1100, the CPU 34 first may check the status of the printer 80. At the same time, the CPU 34 may acquire information regarding the number of media connection portions provided in the printer 80, and the type of the recording medium allowed to be attached to each media connection portion.

At Step S1110, 0 is put in a variable N. N may be variable used in the program in order to confirm information concerned with all the media connection portions, and N may represent the number of media connection portions that have been confirmed. If N is smaller than the number of media connection portions, e.g., “NO” at Step S1120, then at Step S1130, N may be incremented by one (1). At Step S1140, a management area for sub-directory N, e.g., a sub-directory for virtually preparing files and directories based on reflection of the status of the N-th media connection portion, may be reserved in the virtual directory tree.

If the recording medium is attached to the N-th media connection portion, hereinafter referred to as media connection portion N, e.g., “YES” at Step S1150, then at Step S1160, the type of the recording medium then may be confirmed. Successively, at Step S1170, confirmation may be made regarding whether the recording medium attached to the media connection portion N has been formatted. If the recording medium has been formatted, e.g., “YES” at Step S1170, then at Step S1180, the CPU 34 may confirm the total storage capacity and residual storage capacity of the recording medium attached to the media connection portion N, and at Step S1190, the CPU 34 may create a file name indicating the total storage capacity and residual storage capacity of the recording medium.

Successively, at Step S1200, the CPU 34 may create image data indicating the total storage capacity and residual storage capacity of the recording medium, and may recognize the image data as actual data of a file, and may have the file name indicate the total storage capacity and residual storage capacity of the recording medium. Then, at Step S1210, the CPU 34 may create a directory name based on the type of the recording medium attached to the media connection portion N, such that the directory name may indicate that the recording medium of this type may be enabled to be accessed.

On the other hand, if the recording medium is not attached to the media connection portion N in Step S1150, e.g., “NO” at Step S1150, then at Step S1270, the CPU 34 may create a directory name indicating that there is no recording medium attached On the other hand, if the recording medium attached to the media connection portion N has not yet been formatted in S1170, e.g., “NO” at Step S1170, then at step S1280, the CPU 34 may create a directory name indicating that the recording medium has not yet been formatted. Successively, at Step S1220, the management area for the media connection portion N may be initialized (S1220). In this example, various attributes, e.g., that the directory name is a name indicating the type of the recording medium, and the number of the storage portion and the actual location of the directory may be present in the recording medium attached to the storage portion N, may be set in the management area.

At Step S1230, the management area of the root directory may be updated. In this example, the file name created in Step S1190, etc. may be added as a file name of a file stored in the directory. Further, the directory name or names created in Steps S1210, S1270, S1280, etc., may be added as a directory name of a first sub-directory stored in the directory, and the directory name stored in the management area for the media connection portion N in S1220 may be added as a directory name of a second sub-directory stored in the directory.

Successively, this processing returns to Step S1120, and the aforementioned processing is repeated until confirmation about all the media connection portions in the printer 80 is completed, e.g., “YES” at Step S1120. If confirmation about all the media connection portions in the printer 80 are completed, e.g., “YES” at Step S1120: YES, the repetition loop may be terminated because status confirmation of all the media connection portions may be completed. Then, at Step S1240, confirmation may be made regarding whether the current directory is present in either of the virtual directory tree and the actual directory.

If the current directory is present in either of the virtual directory tree and the actual directory, e.g., “YES” at Step S1240, then at Step S1250, confirmation may be made regarding whether the actual location of the current directory is the same as that at a point of time when the virtual directory information was generated previously. If the actual location is on the recording medium, then that the identifier, etc., of the previous recording medium may be stored to be compared with the current identifier.

If the actual directory is the same as that of the previous one, e.g., “YES” at Step S1250, then the virtual directory information generating process may be terminated.

On the other hand, if the designated directory is present neither in the virtual directory tree nor in the actual directory in Step S1240, e.g., “NO” at Step S1240, or if the actual directory is different from that of the previous directory in Step S1250, e.g., “NO” at Step S1250, then at Step S1260, the CPU 34 may recognize the root directory as the current directory, and then may terminate the virtual directory information generating process.

A result obtained in the printer 80 by execution of processing shown in the flow charts of FIGS. 11 to 18 according to an embodiment of the invention, will be described herein using an example.

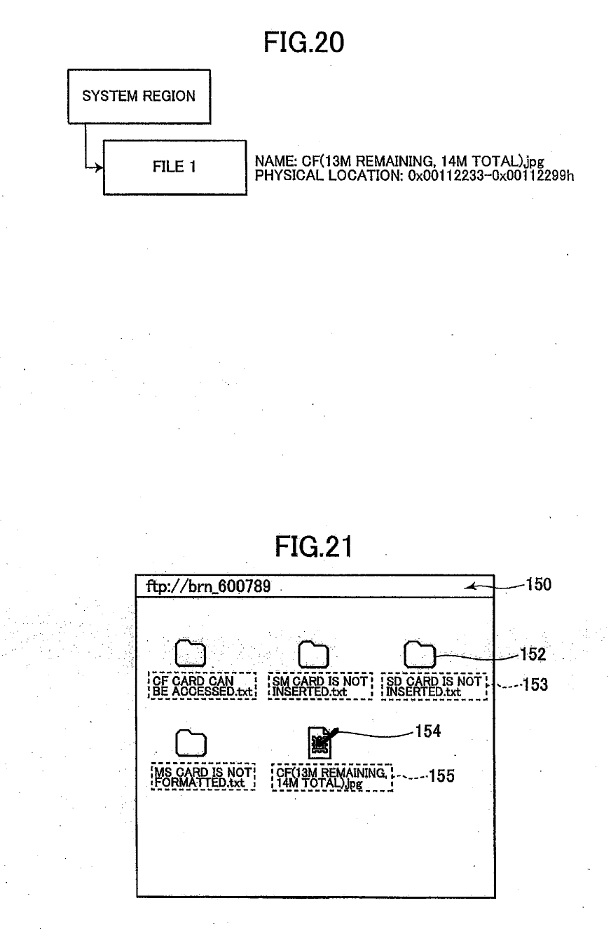

FIG. 19B is a conceptual view showing a virtual directory tree formed by the virtual directory information generating process. FIG. 20 is a conceptual view showing a system area formed by the virtual directory information generating process. FIG. 21 is a view of a screen displayed on the FTP client.

FIGS. 19B, 20, and 21 show that four media connection portions may be provided in the printer 80. Further, any one of CF, SM, MS and SD may be attached to each of the media connection portions. In the example, CF and MS may be attached, and MS may be unformatted. The address of the memory in which actual data, e.g., as shown in FIG. 10, of a file having a file name “CF (residual 13M total 14M).jpg” may be stored as the “actual location” of the file 2.

Although the aforementioned embodiment is an embodiments of the invention, it will be understood by those of ordinary skill in the art that various modifications are included in the scope of the invention.

Although printer 80 may comprise a plurality of media connection portions in this embodiment, in other embodiments of the invention, an apparatus may have only one media connection portion. Further, although this embodiment may describe that a sub-directory is provided such that the recording medium attached to each of the media connection portions is set as an actual directory, in another embodiment of the invention, only one recording medium attached to any one of the media connection portions may be recognized as a sub-directory.

Although this embodiment describes that, for example, the status reflection directory name, the status reflection file name and the contents of the status reflection data are created in the condition that the command is received from the FTP client, in another embodiment of the invention, the names may be created at the time of starting of the server, or in yet another embodiment, the names periodically may be created.

Although this embodiment describes that, for example, the directory name indicating the connection status of the recording medium and the file name indicating the storage capacity of the recording medium may be provided separately, in another embodiment of the invention, a character string indicating the connection status of the recording medium and a character string indicating the storage capacity of the recording medium may be included in one directory name. Further, in other embodiments, other combinations of character strings indicating such elements as status in the directory name, may be created.

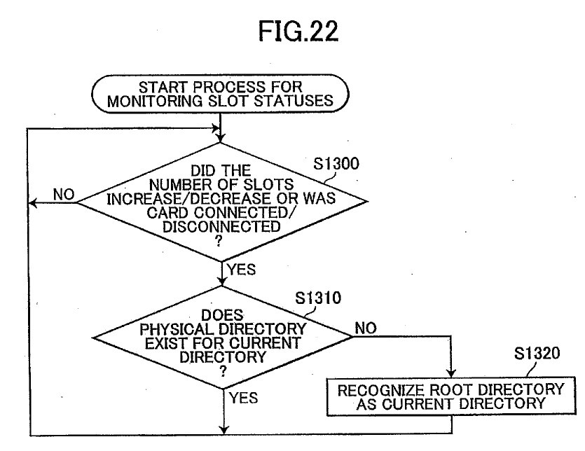

In this embodiment, confirmation may be made in Steps S1240 to S1260 of FIG. 18 regarding whether the actual directory of the current directory is changed, in another embodiment of the invention, confirmation regarding whether the actual directory of the current directory is changed may be made whenever the recording medium in which the actual directory of the current directory is present is attached or detached, or whenever the number of media connection portions is changed. In this embodiment, the root directory may be set as the current directory at a point of time when the actual directory of the current directory is lost, as shown in FIG. 22.

As shown in FIG. 22, in a slot status monitoring process, at Step S1310, the CPU 34 first may confirm whether the actual directory of the current directory is present, e.g., whether the card in which the actual directory is present is detached or whether the slot to which the card is attached is detached, if the number of slots is changed or if the card is attached/detached, e.g., “YES” at Step S1300.

If the actual directory of the current directory is lost, e.g., “NO” at Step S1310, then at Step S1320, the CPU 34 may recognize the root directory as the current directory. This slot status monitoring process repeatedly continues in the CPU 34, while the server runs. In this embodiment, the actual directory may be present in the recording medium. Nevertheless, in another embodiment, the printer 80 may comprise a storage device, e.g., a memory, an HDD, etc., and the actual directory may be present in the storage device, similarly to the server unit.

In this embodiment, a connection status of the recording medium may be used as an example of the apparatus status of the printer 80, in another embodiment of the invention, the status of a function, e.g., a printer function, a scanner function, or a facsimile function provided in the printer 80, other than the function of the FTP type processing apparatus, also may be used. In still another embodiment, the status of the FTP-type processing apparatus may be used as the apparatus status, such that the FTP-type processing apparatus may be reflected in the status reflection file name, and the status reflection data. In still a further embodiment, whether printing can be made, whether reading can be made, whether facsimile transmission can be made, and the like, may be used as an example of the status.

In this embodiment, the printer 80 may be used an example of the FTP type processing apparatus, in other embodiments, the processing apparatus may be applied to any apparatus, e.g., a scanner apparatus, a display apparatus, an audio apparatus, a karaoke apparatus, a digital camera apparatus, a projector apparatus, a disc drive apparatus, a sawing machine, a telephone set, a mobile apparatus, a machine tool apparatus, a robot, etc., and any other apparatus capable of having a server function, and at least one media connection portion.

What is claimed is:

1. A status processor configured to connect to a network, the status processor comprising:
a media connecting unit configured to connect at least one storage media;
a server unit configured to transmit data; and
a directory name setting unit configured to create a status-reflecting directory name on the server unit, wherein the status-reflecting directory name corresponds to a status of at least one of the status processor and the storage media, wherein
the server unit is configured to transmit data that indicates an existence of the directory having the status-reflecting directory name to the network.

2. The status processor of claim 1, further comprising a host device configured to connect to the status processor via the network.

3. The status processor according to claim 1, wherein the server unit is configured to communicate using a File Transfer Protocol.

4. The status processor according to claim 1, wherein the status-reflecting directory name setting unit is configured to create the status-reflecting directory name without storing a directory having the status-reflecting directory name in the at least one storage media.

5. The status processor according to claim 1, wherein the status-reflecting directory name setting unit is configured to create the status-reflecting directory name on the server unit, regardless of a status of the at least one storage media.

6. The status processor according to claim 1, wherein the status-reflecting directory name created by the status-reflecting directory name setting unit corresponds to an availability of the at least one storage media.

7. The status processor according to claim 1, wherein the status-reflecting directory name created by the status-reflecting directory name setting unit corresponds to a connection status of the at least one storage media.

8. The status processor according to claim 1, wherein the status-reflecting directory name created by the status-reflecting directory name setting unit corresponds to a format status of the at least one storage media.

9. The status processor according to claim 1, wherein the status-reflecting directory name created by the status-reflecting directory name setting unit corresponds to a capacity of the at least one storage media.

10. The status processor according to claim 9, wherein the capacity of the at least one storage media includes at least a total capacity of the at least one storage media and a remaining capacity of the at least one storage media.

11. The status processor according to claim 1, wherein the media connecting unit comprises a plurality of media connecting portions,
wherein the status-reflecting directory name setting unit is configured to create the status-reflecting directory name, and the status-reflecting directory name corresponds to at least one of a status of one of the plurality of media connecting portions and a status of the at least one storage media connected to the one of the plurality of media connecting portions.

12. The status processor according to claim 1, wherein the media connecting unit is configured to connect to a plurality of types of storage media, and
wherein the status-reflecting directory name created by the status-reflecting directory name setting unit specifies one type of the plurality of types of storage media.

13. The status processor according to claim 1, further comprising a storing portion configured to store directory data corresponding to a predetermined directory, wherein the predetermined directory is configured to include a file, and
wherein the server unit is configured to transmit data that indicates an existence of the directory having the status-reflecting directory name in the storing portion.

14. The status processor of claim 13, wherein the file has a file name related to the status-reflecting directory name.

15. The status processor of claim 14, wherein the file comprises data corresponding to a status of at least one of the status processor and the at least one storage media.

16. The status processor of claim 13, wherein the file has a file name related to the capacity of the at least one storage media.

17. The status processor according to claim 13, wherein the server unit is configured to transmit data corresponding to a status of at least one of the status processor and the at least one storage media in response to a request for accessing the file.

18. The status processor according to claim 1, further comprising a storing portion configured to store directory data corresponding to a predetermined directory, wherein the predetermined directory further comprises a directory corresponding to the at least one storage media and
wherein the server unit is configured to transmit data that indicates an existence of the directory having the status-reflecting directory name, in response to receiving a request for a content of the predetermined directory.

19. The status processor according to claim 1, further comprising:
a receiving unit configured to receive print data transmitted via the network; and
a printing unit that prints the received print data.

20. A status displaying method including communicating between a host device and a processor via a network, the host device comprising a display unit, the processor comprising a media connecting unit for connecting a storage media, and the status displaying method comprising:
creating a status-reflecting directory name corresponding to a status of at least one of the processor and the storage media;
transmitting data that indicates an existence of the directory having the status-reflecting directory name; and
displaying the transmitted data on the displaying unit.

21. The status displaying method according to claim 18, wherein the step of transmitting data is carried out using a File Transfer Protocol.
